(19) United States
(12) Patent Application Publication
(10) Pub. No.: US 2022/0004952 A1
(43) Pub. Date: Jan. 6, 2022

(54) METHOD FOR SUPPORTING THE CONFIGURATION CHANGEOVER OF AN OPERATING AREA OF A MACHINE FOR PACKAGING PRODUCTS IN GENERAL

(71) Applicant: SASIB S.p.A., Castel Maggiore (Bologna) (IT)

(72) Inventors: Roberto GHIOTTI, Castel Maggiore (Bologna) (IT); Matteo ORSONI, Castel Maggiore (Bologna) (IT); Andrea MONTANARI, Castel Maggiore (Bologna) (IT)

(21) Appl. No.: 17/291,889

(22) PCT Filed: Nov. 25, 2019
(86) PCT No.: PCT/IB2019/060117

§ 371 Date: May 6, 2021

(30) Foreign Application Priority Data
Nov. 28, 2018 (IT) 102018000010653

(51) Int. Cl. G06Q 10/06; G06K 7/14; G06F 16/51; B65B 59/04

(52) U.S. Cl. CPC G06Q 10/06313; G06Q 10/06316; G06Q 10/063114; B65B 59/04; G06K 7/1413; G06F 16/51; G06Q 10/06398

(57) ABSTRACT

A method which can be implemented by a computer supporting the configuration changeover of at least one operating area of a machine for packaging products in general. The operating area includes a first device configured for processing a product according to a first predetermined format and/or first brand. The method includes providing graphic signals identifying the first device to be replaced, a storage position in which to position it, a second device configured to perform a processing of a product in accordance with a predetermined second format and/or second brand and the storage position in which it is placed. Moreover, an image guide system is provided which represents a succession of operations to be performed to replace the first device with the second device. The graphic signals and/or the images are reproduced by means of a graphical interface of the computer.

### TECHNICAL FIELD

This invention relates to the technical sector of machines for packaging products in general.

In particular, the invention relates to a method for supporting a configuration changeover of an operating area of a machine for packaging products in general, which may be, for example, a packaging or wrapping machine for the tobacco industry, but without thereby limiting the scope of the invention.

### BACKGROUND ART

In the field of industrial processes it may be necessary to vary some or all of the features of a product which is made.

For example, there might be the need to change the size of the product, for example modifying one or more dimensions, in such a way as to adapt it to new production requirements or to changed operating conditions.

For this purpose, packaging machines are known which are divided into operating areas, each of which is designed to perform the various steps for processing the product by using suitable devices which are in turn configured for making a product according to a predetermined format and/or brand.

If it is necessary to change the structural, aesthetic or functional characteristics of the product to be made, an operator may replace the devices present in the work areas, in such a way as to suitably modify the operating processes which lead to the production of the product, especially in terms of size of the material and semifinished items processed by the machine.

However, the Applicant has observed that the replacement procedure is extremely onerous and inefficient.

In fact, modern industrial plants have structural dimensions and complexity such as to require extremely long times for changing the configuration of the packaging machines.

The replacement of the devices of an entire packaging machine, in such a way as to allow a different product to be made, may require even more than one working day to be completed.

Moreover, the complexity of the devices and their interconnections inside the individual operating areas means that a high level of specialization is required so that the device for making a product can be replaced correctly and safely with that designed for making a further product having different features.

Moreover, it might be necessary to replace a large number of devices of the machine, each potentially designed to perform a different type of processing, therefore having unique features which may result in the need to perform different replacement procedures depending on the device being operated on.

### Aim of the Invention

In this context, the technical purpose which forms the basis of the invention is to propose a method for supporting a configuration changeover of an operating area of a machine for packaging products in general which overcomes at least some of the above-mentioned drawbacks of the prior art.

In particular, the aim of the invention is to provide a method for supporting the configuration changeover of an operating area of a machine for packaging products in general which is able to optimise the processes and the operations which allow the machine to be prepared for making products having different features.

The technical purpose indicated and the aims specified are substantially achieved by a method for supporting a configuration changeover of an operating area of a machine for packaging products in general comprising the technical features described in one or more of the appended claims.

The invention describes a method which can be implemented by a computer supporting the configuration changeover of at least one operating area of a machine for packaging products in general.

In particular, the operating area comprises at least a first device configured for processing a product according to a predetermined first format and/or first brand.

The method comprises the following steps:
providing a first graphic signal identifying the first device to be changed;
providing a second graphic signal identifying a second device configured for performing a processing of a product in accordance with a second predetermined format and/or second brand;
providing a third graphic signal identifying a first storage position in which to place the first device;
providing a fourth graphic signal identifying a second storage position in which the second device is located;
providing an image guide system representing a succession of operations to be performed to replace the first device with the second device following the correct identification of the devices involved in the replacement and their respective storage positions.

Advantageously, the graphic signals and/or the images are reproduced by means of a graphical interface of the computer.

Advantageously, the method according to the invention makes it possible to make the procedure for replacing devices of the operating area sequential, guiding the operator through the entire process, thus providing a standardization of the process together with all the necessary information in such a way as to avoid errors by the operator.

Advantageously, the method described above may be applied in parallel to several operating areas of the packaging machine simultaneously by several operators, thus allowing a reduction in the time necessary for changing the configuration of the entire packaging machine.

The invention also relates to a system for managing the configuration changeover of at least one operating area of a machine for packaging products in general, wherein the operating area comprises at least a first device configured for processing a product according to a predetermined first format and/or first brand.

The system comprises a database in which are stored a plurality of graphic signals and/or images representing a respective plurality of devices which can be replaced, storage positions and/or operations to be performed for replacing a device.

The system also comprises at least one computer connectable to the control unit to receive from the database the graphic and/or image signals.

In particular, the at least one computer is configured to execute a method for supporting the configuration changeover of at least one operating area of a packaging machine according to the invention.

Advantageously, the system described herein makes it possible to optimise the configuration changeover process allowing an operator to be provided with all the information necessary to identify the position of the components to be replaced and the steps necessary to complete the replacement.

The invention also relates to a configurable system for making products in accordance with different formats and/or brands.

The system comprises a plurality of devices configured to perform a processing of a product in accordance with a respective plurality of formats and/or a respective plurality of predetermined brands.

The system also comprises a machine for packaging products in general which has at least one operating area which comprises at least one device configured for processing a product according to a predetermined first format and/or first brand and at least one storage system which has a plurality of storage seats designed to house respective devices.

The system also comprises a system for supporting the configuration changeover of at least one operating area of a machine for packaging products in general made according to the invention.

### BRIEF DESCRIPTION OF THE DRAWINGS

Further features and advantages of the invention are more apparent in the approximate and hence non-limiting description of a preferred, non-exclusive embodiment of a method for supporting a configuration changeover of an operating area of a machine for packaging products in general, illustrated in the accompanying drawings in which:

FIGS. 1A-1E show a representation of the succession of operating steps of the method according to the invention;

FIG. 2 schematically shows a machine for packaging products in general;

FIG. 3 schematically shows a representation of various storage positions for devices and tools according to the invention;

FIG. 4 shows a particular embodiment of a storage system according to the invention.

### DETAILED DESCRIPTION OF PREFERRED EMBODIMENTS OF THE INVENTION

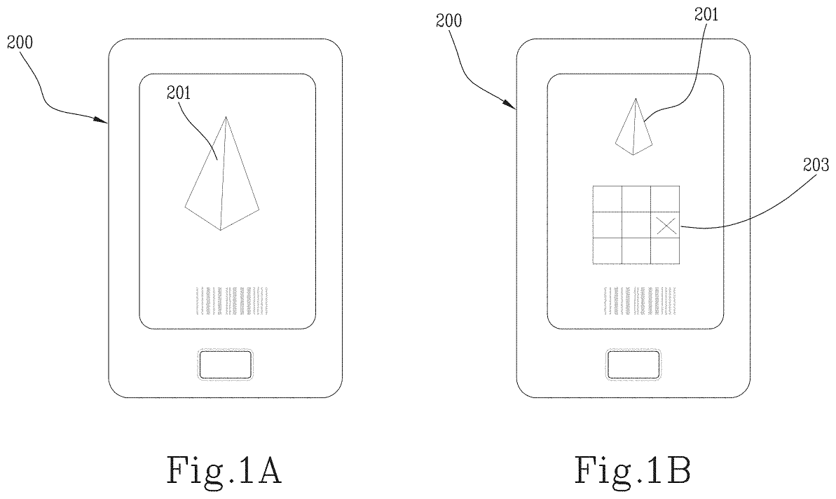

The method for supporting the configuration changeover of at least one operating area 110 of a machine 100 for packaging products in general, of which some operating steps are shown in FIGS. 1A-1E, makes it possible to make the process for systematic replacement of at least some of the components present inside the operating area 110 sequential, guiding the operator through the various steps necessary to complete it.

In this way, it is possible to prepare the packaging machine 100 to make a plurality of different products.

For the purposes of the invention, the expression “configuration changeover” refers to a replacement of some components present in the packaging machine 100 in order to prepare it for the production of products which differ from each other in terms of structural, aesthetic and/or functional characteristics.

In particular, the method according to the invention can be implemented by a computer 200 and allows the replacement of at least a first device 111 present inside an operating area of a packaging machine with a second device 112.

The first and second devices 111 and 112 are respectively configured for processing a product according to a predetermined first format and/or first brand and for processing a product according to a predetermined second format and/or second brand.

In other words, each device 111, 112 is able to perform the processing of a product in accordance with respective sizes and/or brands and their application inside the operating area 110 makes the packaging machine 100 able to process and/or make products different to each other and according to the respective sizes and/or brands.

As shown in FIG. 1A, the method comprises providing the operator with a first graphic signal 201 representing the first device 111 to be replaced.

In other words, an indication is provided which allows the operator to identify inside the operating area 110, in which the operator is working, which is the first device 111, that is to say, which device must be replaced.

At least a second graphic signal 202 is also provided identifying a second device 112 configured for performing a processing of a product in accordance with a predetermined second format and/or second brand;.

In this way, the device which must be applied to the operating area 110 to change the configuration of the packaging machine 100 is identified in a clear and unique manner in such a way as to prepare it for the production of products in accordance with the predetermined second format and/or second brand.

At least a third graphic signal 203 is also provided identifying a first storage position 211 in which to place the first device 111.

The third graphic signal 203 may be provided individually, or, as shown in FIG. 1B, at the same time as the first graphic signal 201.

The information provided by means of the third graphic signal 203 makes it possible to indicate to the operator which is the correct position in which to store the first device 11, in such a way that it can be guaranteed that, if it is necessary to reapply it in the packaging machine 100, the first device 111 is immediately available since its storage position it is known in a unique and accurate manner.

A fourth signal 204 is also provided identifying a second storage position 212 in which the second device 112 is positioned.

This information makes it possible to indicate to the operator which is the correct position in which the second device 112 can be found and picked up, in such a way that it is possible to guarantee its finding in a fast and efficient manner, since its storage position is known in a unique and accurate manner.

The second graphic signal 202 and the fourth graphic signal 204 may be supplied individually and sequentially to the operator, or, as shown in FIG. 1C, they may be supplied to the operator simultaneously.

In other words, for all the devices 111, 112 involved in the replacement process signals are provided which allow the operator to identify the devices 111, 112 involved in the replacement (more specifically, the first device 111 to be replaced and the second device 112 which must replaced it) and where they are stored or must be stored.

The method according to the invention also comprises, as shown in FIG. 1D, providing an image guide system 205, wherein the images represent a succession of operations to be performed to replace the first device 111 with the second device 112.

In this way, the operator receives all the information necessary to change the configuration of the packaging machine 100, using simple instructions to be interpreted and by means of a sequential procedure which avoids errors due to incorrect management of the devices 111, 112 both in terms of replacement procedure and respective storage positions 211, 212.

In particular, the image guide system 205 shows information necessary for the replacement of the devices 111, 112 as a function of and after the correct interpretation of the signals 201, 202, 203, 204 by the operator.

Advantageously, all the graphic signals 201, 202, 203, 204 and/or the images 205 are reproduced by means of a graphical interface of the computer 200.

It is also possible to connect the computer 200 to a database in such a way that the computer can receive from it the graphic signals 201, 202, 203, 204 and/or the images 205.

In order to guarantee that the configuration changeover occurs without errors, the method also comprises, after each of the above-mentioned steps, that is to say, the steps in which the graphic signals 201, 202, 203, 204 or the images 205 are provided, a step aimed at checking the correct interpretation of the respective graphic signal 201, 202, 203, 204 and/or of the images representing the sequence of operations to be performed by an operator after and as a function of an input entered by the operator and identifying an actual operation performed.

In other words, after each of the steps in which the operator has received, in particular by means of the graphical interface of the computer 200, each of the graphic signals 201, 202, 203, 204 and the images 205, a checking procedure is started, by means of a suitable input signal which can be entered by the operator, aimed at checking the correct interpretation of the information provided by the computer 200.

This checking procedure is performed on the basis of the information content of the input signal which can be entered by the operator.

In particular, it is possible to uniquely associate to each device 111, 112 and each storage position 211, 212 respective identification codes, which, as shown for example in the accompanying drawings, may be bar codes.

The input which can be entered by the operator is therefore an input representing the identification code which is uniquely coupled to a device 111, 112 or to a position 211, 212.

According to this embodiment, the checking step then performs a comparison between the identification code and a respective reference code representing a correct first or second correct device or storage position.

Preferably, the method described here comprises generating an error signal if the check is negative.

In other words, the identification code makes it possible to uniquely recognise the operation actually performed by the operator on the basis of the instructions received from the computer 200, in particular this operation may be an operation for identifying a device 111, 112 or for identifying a storage position 211, 212.

The identification code is then compared with a reference code which is uniquely associated with the correct operation which the computer 200 has indicated to the operator to perform.

If the two codes coincide, then the operation has been performed correctly (that is to say, the operator has correctly identified the devices 111, 112 and the respective storage positions 211, 212), otherwise it is possible to generate an error signal, for example an optical and/or acoustic signal, which alerts the operator of the incorrect execution of one of the steps necessary for changing the configuration of the packaging machine 100.

The method according to the invention also comprises providing a fifth graphic signal 206 identifying a tool 113 designed to promote the removal of the first device 111 and/or the assembly of the second device 112.

In other words, an indication is provided which makes it possible to identify which tool 113 or tools 113 are necessary to perform the operation for changing the configuration of the packaging machine 100.

A sixth graphic signal 207 can also be provided identifying a third storage position 213 in which the at least one tool 113 is positioned.

In particular, the sixth graphic signal 207 may be displayed and supplied to the operator simultaneously with the fifth graphic signal 206, as shown by way of example in FIG. 1E.

Moreover, the checking step may also be performed for checking the correct interpretation by the operator of the fifth and/or sixth graphic signal 206, 207.

In other words, it is possible to also associate a unique identification code to the tool 113 and to the third storage position 213 in which it is located, in such a way that following their identification it is possible for the operator to compare the correct reference code of the tool 113 or of the third storage position 213 (that is to say, those indicated by the method by means of the graphical interface of the computer 200) with the identification codes respectively of the tool 113 or of the third storage position 213 identified as a function of how the operator has interpreted the information contained in the fifth and sixth signal 206, 207.

In this case, too, it is possible to generate an error signal, in particular of the optical and/or acoustic type, for alerting the operator if a given identification code and the respective reference code do not correspond.

Advantageously, the invention achieves the preset aims overcoming the drawbacks of the prior art by providing the user with a method which supports the operator to perform a process for changing the configuration of at least one operating area 110 of a packaging machine 100.

This result is obtained by means of a method which provides precise and timely information to the operator, placing the operator in the conditions of simply and quickly identifying which devices 111, 112 are involved in the configuration changeover process and where these devices 111, 112 are positioned, so as to be able to find them or where they must be placed once removed from the packaging machine 100.

The method according to the invention also allows the operator to interactively check if the interpretation given by the operator to the instruction received by means of the computer 200 is correct or not.

The invention also relates to a method which can be implemented by a computer 200 for supporting a configuration changeover of a machine 100 for packaging products in general which comprises at least one operating area 110 wherein the method described above is iterated for each operating area 110 of the packaging machine 100.

In particular, the method is performed on each operating area 110 simultaneously.

In this way it is possible to optimise the process for changing the configuration of the entire packaging machine 100, since it is possible to provide different operators with respective computers 200, in such a way that each of them can change the configuration of a respective operating area 110.

In this way it is possible to operate in parallel on several operating areas 110 of the packaging machine 100 speeding up the configuration changeover process.

The invention also relates to a system for managing the configuration changeover of at least one operating area 110 of a machine 100 for packaging products in general as described.

The system comprises a database in which are stored a plurality of graphic signals 201, 202, 203, 204, 206, 207 and/or images 205 representing a respective plurality of devices 111, 112 which can be replaced, storage positions 211, 212 and/or operations to be performed for replacing a device 111, 112.

In other words, the database comprises all the information necessary to guide the operator through the steps necessary to change the configuration of the packaging machine 100.

More specifically, the database comprises at least a first graphic signal 101 identifying the first device 111 to be changed; at least a second graphic signal 202 identifying the second device; at least a third graphic signal 203 identifying a respective first storage position 211 in which to place the first device 111; at least a fourth graphic signal 204 identifying a respective second storage position 212 in which the second device 112 is placed and a plurality of images 205 representing a succession of operations to be performed for replacing the first device 111 with the second device 112.

The database may also comprise information relative to the tools 213 necessary to actuate the configuration changeover procedure, in particular to facilitate the replacement of the first device 111 with the second device 112.

In this context, the database stores at least a fifth graphic signal 206 identifying a respective tool 113 and at least a sixth graphic signal 207 identifying a respective third storage position 213 which defines a position for storing the respective tool 113.

Moreover, the database which can be consulted can be edited at least for generating, modifying or storing the graphic signals 201, 202, 203, 204, 206, 207 and/or the images 205.

In other words, it is possible to modify the information contained in the database if it is necessary to update or modify the position of certain devices 111, 112 and/or tools 113 or to enter information relative to different further procedures for changing the configuration of the packaging machine 100 or variations to those already stored, for example modifying the images 105 present in the database.

In particular, this functionality makes it possible to update the information relative to the storage positions 211, 212, 213 if it is necessary to modify them to improve the storage processes of the devices 111, 112 and/or of the tools 113.

The system also comprises at least one computer 200 connectable to the database to receive from it the graphic signals 201, 202, 203, 204, 206, 207 and/or the images 205,

The computer is configured to provide the graphic signals 101, 102, 103, 104, 106, 107 and/or the images 105 to an operator.

Preferably, the computer 200 is configured to perform a method for supporting the configuration changeover of at least one operating area 110 of a packaging machine 100 as described above.

In particular, each computer 200 is a portable terminal, for example a smartphone, a tablet or a handheld computer.

Moreover, the computer 200 may comprise a sensor, preferably an optical type sensor, configured for detecting the identification code of a respective device 111, 112 or storage position 211, 212.

The computer 200 is configured for checking an identity between the identification code and a reference code representing the correct device 111, 112 or storage position 211, 212.

The computer is also configured to generate an error signal in the case of a negative check, preferably an optical and/or acoustic signal.

The sensor is also configured for detecting the identification code of a tool 113 and its storage position 213, the computer 200 is therefore configured for checking an identity between the identification code and the respective reference code generating preferably also in this case the error signal in the case of a negative check.

The invention also relates to a configurable system for making products in accordance with different formats and/or brands which comprises plurality of devices 111, 112 configured to perform a processing of a product in accordance with a respective predetermined plurality of formats and/or plurality of brands.

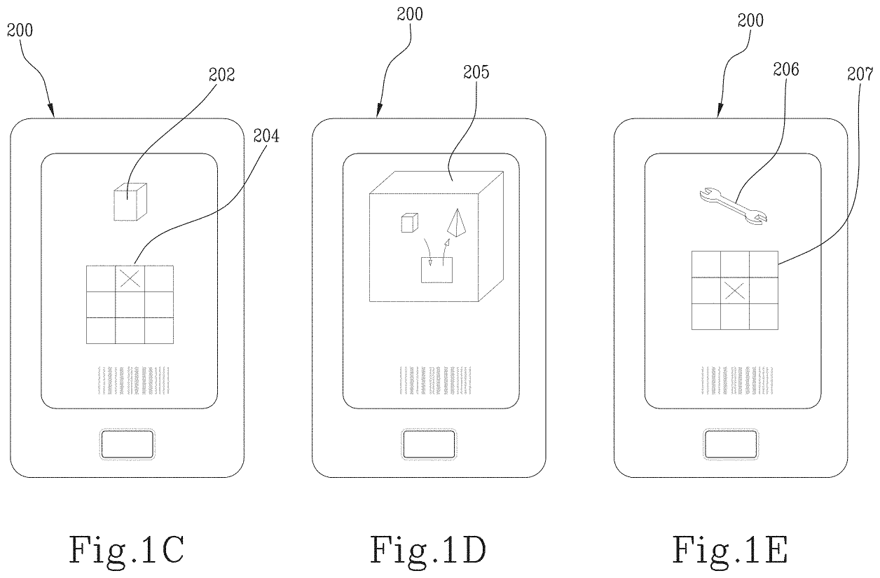

The system therefore comprises a packaging machine 100, of which a schematic representation is shown in FIG. 2, which has at least one operating area 110 in which is mounted or applied at least a first device 111 of the plurality of devices 111, 112 which is configured in particular for processing a product according to a predetermined first format and/or first brand.

In other words, the plurality of devices 111, 112 comprises all the devices necessary to prepare the packaging machine 100 for making a plurality of products different in size and/or brand.

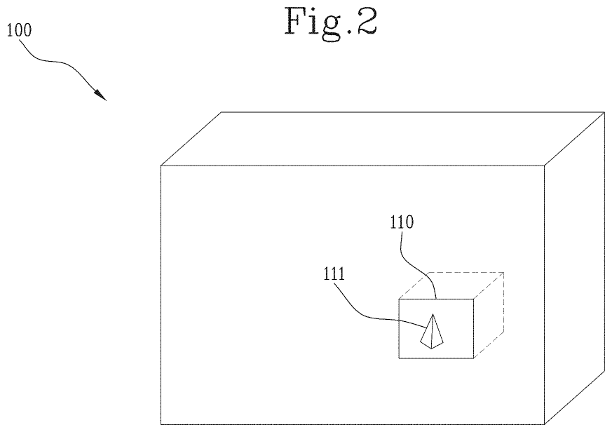

The system also comprises at least one storage system 300, shown schematically in FIG. 3, which has a plurality of storage seats 301 which are designed to house respective devices 111, 112.

Each storage seat 301 defines a storage position 211, 212 for respective devices 111, 112, in such a way as to allow the correct storage when these are not applied to the packaging machine 100.

Advantageously, the storage system 300 may also have at least one storage seat 301 which defines a third storage position 213 designed to house a respective tool 113 which can be used to promote the removal and/or the assembly of a device 111, 112 relative to the operating area 110.

According to a preferred embodiment, the system comprises a plurality of storage systems 300 each of which is configured to house respective devices 111, 112 which are in turn configured to perform a processing of a product in accordance with a predetermined same format and/or same brand.

In other words, each storage system 300 is designed to house only the devices 111, 112 relative to a predetermined format and/or brand, in such a way that to perform the configuration changeover it is sufficient to identify two storage systems 300, a first storage system in which the first device 111 will be placed and a second storage system in which, on the other hand, the second device 112 can be located.

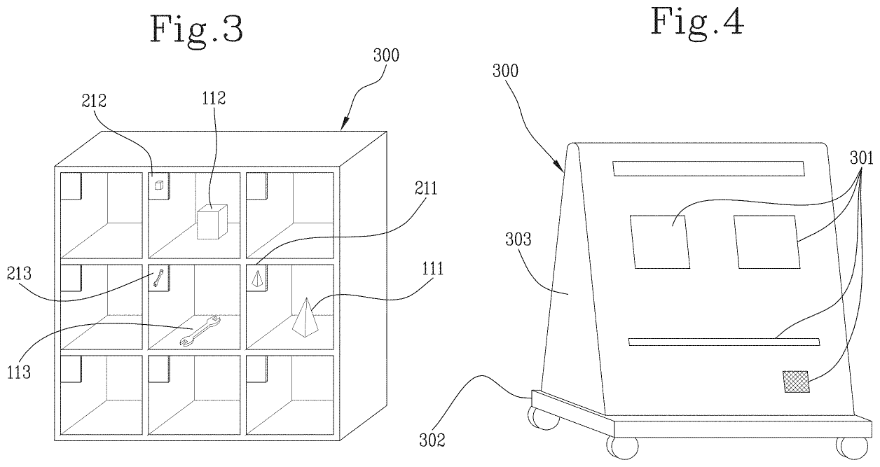

Preferably, as shown in FIG. 4, each storage system 300 comprises a movable carriage 302 and a plate 303 mounted on it.

The plate 302 defines the plurality of storage seats 301, and preferably comprises a rack to which the devices 111, 112 and/or the tools 113 can be associated.

The system also comprises a system for supporting the configuration changeover of at least one operating area 110 of a machine 100 for packaging products in general as described above.

In particular, the database of this system will contain all the information necessary to uniquely identify each device 111, 112 and its position inside the at least one storage system 300 and the information necessary to support an operator in the configuration changeover of the packaging machine 100, that is to say, in the replacement of the devices 111, 112 in such a way as to prepare the machine to make the products according to a suitable predetermined format and/or brand.

1. A method which can be implemented by a computer for supporting a configuration changeover of at least one operating area of a machine for packaging products in general, the operating area comprising at least a first device configured for processing a product according to a first format and/or a first predetermined brand, the method comprising the steps of:
providing a first graphic signal identifying at least a first device to be changed;
providing a second graphic signal identifying at least a second device configured for performing a processing of a product in accordance with a second format and/or a second predetermined brand;
providing a third graphic signal identifying a first storage position in which to place the first device;
providing a fourth graphic signal identifying a second storage position in which is placed the second device;
providing an image guide system, the images representing a succession of operations to be performed designed to change the first device with the second device as a function of their identification using the graphic signals (201, 202, 203, 204);
wherein the graphic signals and/or the images are reproduced by means of a graphical interface of the computer.

2. The method according to claim 1, wherein after each providing step a step is performed for checking the correct interpretation of the respective graphic signal and/or of the images by an operator following a input inserted by the operator, the input being an identifier of an actual operation performed by the operator.

3. The method according to claim 2, wherein each first and second device and each first and second storage position are uniquely associated to a respective identification code, preferably a bar code, the input which can be inserted being an input representing the identification code and wherein a comparison is performed in the checking step between the identification code and a respective reference code representing a first or second device or first or second correct storage position, preferably generating an error signal if the check is negative.

4. The method according to claim 1, comprising the steps of:
providing a fifth graphic signal identifying a tool designed to promote the removal of the first device and/or the assembly of the second device; and/or
providing a sixth graphic signal identifying a third storage position in which the tool is positioned.

5. The method according to claim 1, comprising the step of connecting the computer to a database to receive from the database the graphic signals and/or images.

6. A method which can be implemented by a computer for supporting a configuration change of a machine for packaging products in general comprising at least one operating area, the method comprising the step of performing the method according to claim 1 in each operating area simultaneously.

7. A system for managing the configuration changeover of at least one operating area of a machine for packaging products in general, the operating area comprising at least a first device configured for processing a product according to a first format and/or a first predetermined brand, the system comprising:
a database comprising:
at least a first graphic signal identifying the first device to be changed;
at least a second graphic signal identifying a second device configured for performing a processing of a product in accordance with a second format and/or a second predetermined brand;
at least a third graphic signal identifying a respective first storage position in which to place the first device;
at least a fourth graphic signal identifying a respective second storage position in which is placed the second device;
images representing a succession of operations to be performed designed to change the first device with the second device as following their identification using the graphic signals;
at least one computer connectable to the database to receive from the database the graphic signals and/or images and comprising a graphical interface configured to provide the graphic signals and/or images to an operator.

8. The system according to claim 7, wherein the computer is a portable terminal, the portable terminal preferably being one between: a smartphone, a tablet or a handheld computer.

9. The system according to claim 7, wherein the database can be consulted and edited at least for generating, modifying or storing the graphic signals and/or images.

10. The system according to claim 7, wherein the computer comprises a sensor, preferably an optical sensor, configured for detecting an identification code of a respective device or storage position, the computer being configured to check an identity between the identification code and a reference code representing the device or correct storage position preferably generating an error signal if the check is negative.

11. The system according to claim 7 wherein the database further comprises:
at least a fifth graphic signal identifying a tool designed to promote the removal of the first device and/or the assembly of the second device;
at least a sixth graphic signal identifying a third storage position in which the tool is positioned.

12. A configurable system for making products in accordance with different formats and/or brands comprising:
a plurality of devices configured to perform a processing of a product in accordance with a respective plurality of formats and/or a respective plurality of predetermined brands;
a machine for packaging products in general having at least one processing area comprising at least one first device configured for the processing of a product according to a first format and/or a first predetermined brand;
at least one storage system having a plurality of storage seats designed to house respective devices;
a system for supporting a configuration changeover of at least one operating area of a machine for packaging products in general according to claim 7.

13. The system according to claim 12, wherein the storage system comprises at least one storage seat designed to house a respective tool designed to promote the removal and/or the assembly of a device relative to the operating area.

14. The system according to claim 12, comprising a plurality of storage systems, each storage system being configured to house respective devices configured to perform a processing of a product in accordance with a same format and/or same predetermined brand.

15. The system according to claim 12, wherein each storage system comprises a movable carriage and a plate mounted on the movable carriage and designed to define the plurality of storage seats, preferably the plate comprising a rake.
